(19) United States
(12) Patent Application Publication
(10) Pub. No.: US 2007/0233362 A1
(43) Pub. Date: Oct. 4, 2007

(54) Manufacturing facility control system

(76) Inventors: Wayne F. Carriker, Forest Grove, OR (US); Mandar Chincholkar, Beaverton, OR (US)

Correspondence Address: TROP PRUNER & HU, PC, 1616 S. VOSS ROAD, SUITE 750, HOUSTON, TX, 77057-2631, US

(21) Appl. No.: 11/393,881

(22) Filed: Mar. 30, 2006

(51) Int. Cl. G01C 21/00

(52) U.S. Cl. 701/200

(57) ABSTRACT

A facility control system to determine a more efficient route for moving materials from one object to another object. A more efficient route for the material can be determined by an algorithm. The algorithm can take into account data including the priority of the material, the type of object at the current position of the material, the type of object at the new position of the material, the transport systems connected to the objects, and other data. The algorithm can determine a more efficient route faster than searching a table of all possible routes in a facility.

### BACKGROUND

The embodiments of this invention relate generally to a control system for use in a manufacturing facility.

Manufacturing facilities can include tools, storage, and transport systems. Different tools are used in completing tasks to make a final product. The storage units are used to temporarily hold a product at different stages of completion while the product is waiting to be transferred to the next tool. The tools and the storage units can be known as objects. The products at various stages of completion can be known as materials. The transport system can connect all of the tools and all of the storage units together.

For a manufacturing facility to run efficiently, a more efficient route between a tool and another tool, a tool and a storage unit, a storage unit and another storage unit, or a storage unit and a tool must be determined. The transport system can have all of the routes in the facility defined in a table before the transport system begins operations. Entering the routes can be done by humans, creating the possibility of error and inefficient routes.

### BRIEF DESCRIPTION OF THE DRAWINGS

FIG. 1 depicts a flow chart for one embodiment of a method of controlling a facility.

FIG. 2a depicts an embodiment of a facility.

FIG. 2b depicts an embodiment of a storage unit.

FIG. 3 depicts a data structure representation of the facility in FIG. 1.

FIG. 4 depicts one embodiment of a device to control a facility.

FIG. 5 depicts one embodiment of a system in a facility.

### DETAILED DESCRIPTION

A facility can have storage units, tools, and transport systems between the storage units and the tools.

The storage units can be automated storage and retrieval systems. An automated storage and retrieval system can be a storage system including shelves and automated systems to move the materials from one shelf to another and eventually off to another automated storage and retrieval system or to a tool via a transport system.

In a silicon fabrication facility, the storage units are known as stockers and the material stored in the stockers is known as lots. Stockers and transport systems that can be used are available from Daifuku of Osaka, Japan.

The tools can be arranged in tool bays. The tool bays can be a group of tools connected to a transport system. The transport system for the tool bay can be coupled to another transport system to move the material to any other storage unit or tool in the facility. Examples of tools that can be used in a semiconductor facility are scanners, implanters, and wet benches. However, the embodiments are not limited to semiconductor facilities.

The tool bays can include tools of a particular type and the tools and tool bays can be located together in an area of a facility. The tool bay and tool layouts in a facility can be located for a more efficient route that a material is expected to follow or the tool bay and tool layouts can be located for a more efficient use of the available space in the facility.

The transport system can include one or more tracks with automated vehicles that move along the track to pickup a material and move the material to a destination. The transport systems can be interbay transport loops, and intrabay transport loops. The intrabay transport loops can transport materials between the tools in the tool bays and the storage units. The interbay transport loops can transport materials between storage units. The interbay and intrabay transport loops can be divided into groups. The groups of interbay transport loops can be connected by interbay cross transports and the groups of intrabay transport loops can be connected by intrabay cross transports. There can be multiple interbay or intrabay transport loops in a facility including interbay and intrabay transport loops located at different elevations.

In a facility, an execution system can make a request to move a material from one object, such as a tool or a storage unit, to another object. The execution system can receive information about the status of the materials in a facility. The status can include the state of completion of the materials. The execution system can use the status information to determine the sequence of tools for a material in the facility. The execution system can determine the priority of the materials being moved. When the execution system determines that a material can be moved to a new object, the current position, new position, and priority may be sent to the control system. The position or location of an object can be a distance relative to a fixed point, the distance between adjacent objects, or another identifier of position or location.

A control system can be used to determine a more efficient route when a request is received to move a material from one object to another object. The control system can use an algorithm to determine a more efficient route based on information stored in digital model of the facility and the information received from an execution system or a manual input. The control system can determine another route if an unavailable transport system is used in the more efficient route. A transport system may be unavailable for maintenance or a transport system may be performing other tasks.

The digital model of a facility can be in the form of a configuration file. The configuration files can include data structures, which can be a character representation of the position and connections of the objects and transport systems in a facility. The characters can be numbers, letters, or punctuation that can be used to represent the facility.

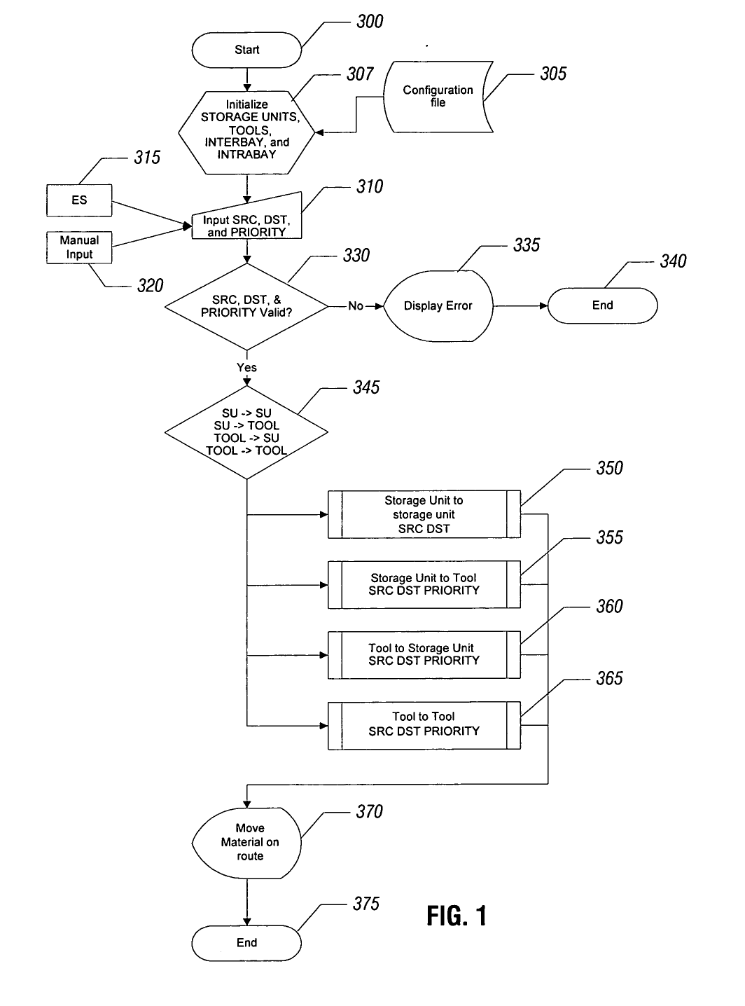

FIG. 1 depicts a flow chart of one embodiment of a control system. The operation of a facility starts at block 300. From there, the storage units, tools, interbay transports, cross-transports, and intrabay transports can be initialized at block 307. A configuration file at block 305 can be read at block 307. The configuration file can be a data structure representation of the facility. At block 315, the execution system can send source information, destination information, and priority information to the control system at block 310. The source information indicates the current position of a material to be moved. The destination information indicates the position of the material after the move. The priority data indicates the priority of the material at the source position relative to other material that can be moved. A manual input can be accepted at block 320 to input the source, destination, and priority information to the control system at block 310.

The control system can check to see if the source, destination, and priority are valid data values at diamond 330. The source, destination, and priority can be invalid if the manual input at block 320 is incorrect or if there is an inconsistency between the execution system at block 315 and the configuration file at block 305. If the source, destination, and priority are not valid, an error can be displayed at block 335 and the control system function ends at block 340. If the source, destination, and priority are valid in diamond 330, then at diamond 345 the control system can determine which type of move is being requested.

The different types of moves that can be requested by the execution system and carried out by the control system are shown by blocks 350, 355, 360, and 365. In block 350, the move that is described is from a storage unit to another storage unit. In block 355, the move is from a storage unit to a tool. In block 360, the move is from a tool to a storage unit, and in block 365, the move is from a tool to another tool. Each of the blocks 350, 355, 360, and 365 can have different algorithms that determine a more efficient route for each requested move. The blocks 350, 355, 360, and 365 can also have different priority values associated with different types of moves. For example, any move requiring a tool may have a higher priority than a move from a storage unit to another storage unit in one embodiment.

Once the algorithm at block 350, 355, 360, or 365 has determined a more efficient route between two of the objects, the material can be moved at block 370 on the more efficient route and the facility control system can end at block 375.

A more efficient route is not always the shortest route. The algorithm can take into account many factors in determining a more efficient route. The algorithm at blocks 350, 355, 360, and 365 can first generate all possible routes for a given source and destination combination. The algorithm can apply weights based on the cost of using transport devices for each of the routes generated. In one embodiment, the movement of materials from source positions to destination positions can be performed by multiple transport devices, but the movement of other materials can be performed by one of the multiple transport devices. The cost of using the one transport device increases when there are multiple transport devices available and that transport device can be more efficiently used for routes from a source to a destination where there is one transport device. The cost of using a transport device can also include the speed of the transport device, the maintenance costs, or the frequency of maintenance. A less expensive routing option can then be projected as a more efficient choice.

The algorithm can be used to identify a more efficient routing option for storage unit-to-tool, tool-to-storage unit, tool-to-tool, and storage unit-to-storage unit moves, and its usefulness is evident for multiple-transport device source and destination combinations. The algorithm can handle multiple material priorities and the relative importance of storage unit-to-tool versus tool-to-storage unit transactions. The control system can check the relative material prioritization and determine that the priority of a material is higher than another material. When a higher priority material is going to be moved, a control system can override the move priority, such as tool-to-tool being higher than the storage unit-to-tool priority, and move the higher priority material first.

The algorithm can be divided into different algorithms for each type of move. In addition to the position of objects, the algorithm can take into account data variables received from the execution system and the configuration file which can include the priority of a material, the type of objects at the current position and the new position of a material, the priority and availability of the transport systems, the availability of a direct route, or whether the material is going to be moved to an intermediate storage unit. The data used by the algorithm when a move is requested by the execution system can be updated in the configuration file, by the execution system, or by user input. The updated data can change a more efficient route generated by the algorithm.

The configuration file and the algorithms in one embodiment can generate the static-route table before a move is requested. This can result in a static-route table free from the errors that may result from entry by humans, and a static-route table that includes all the possible routes.

Dynamically generating a more efficient transport device and routing option can allow the addition of a tool or storage unit with minimal changes in the configuration file, such as a few characters or a few lines of data, as compared to the static-route table where many thousand additional routes may be required for each added tool or storage unit. Searching a table of possibly over one million routes is a lengthy and slow process as compared to the use of an algorithm and configuration file.

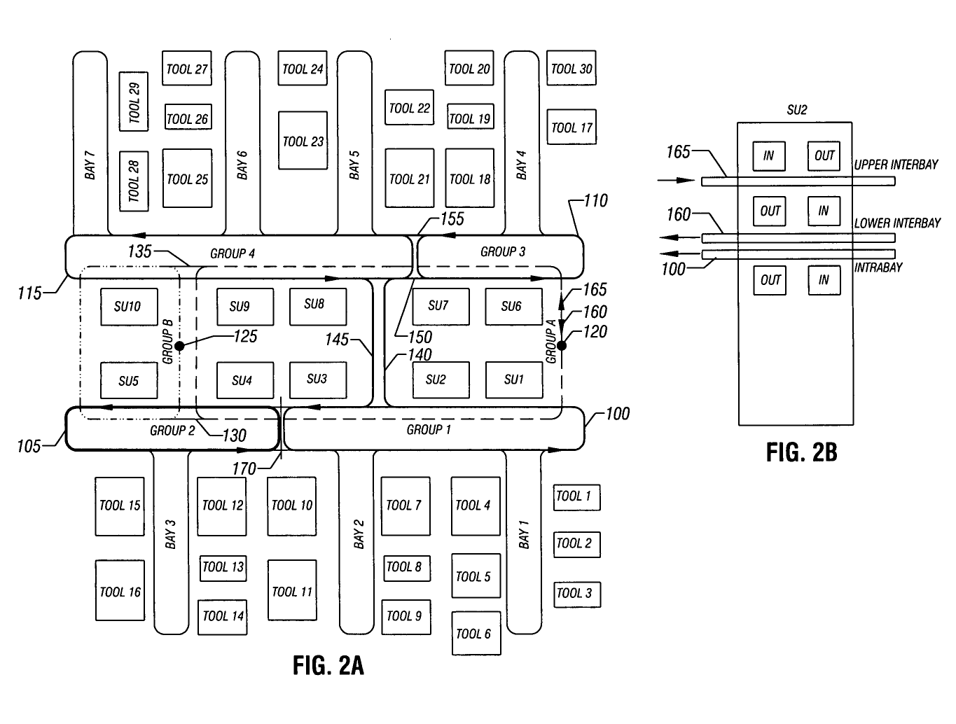

FIG. 2a depicts an example of a facility to illustrate an embodiment of a control system. In one embodiment, the control system can be used in a facility of any size and any configuration with an automated transport system.

The facility of FIG. 2a can have a group of storage units SU1 through SU10 aligned down the middle of the facility. The storage units can be grouped into groups A and B. Group A can include storage units SU1-SU4 and SU6-SU9. Group B can include storage units SU5 and SU10. The location of the storage units can be determined relative to a fixed point. Group A and Group B can have different fixed points 120 and 125. The storage units SU1 through SU10 can be connected by interbay transport loops 160 and 165. Interbay cross transports 130 and 135 can connect the interbay transport loops of Group A and Group B between the storage units SU4 and SU5, and storage units SU9 and SU10. The interbay and intrabay transport systems can be uni-directional in one embodiment. The upper interbay transport loop 165 operates in a counterclockwise direction in one embodiment. The lower interbay transport loop 160 operates in a clockwise direction in one embodiment.

The intrabay transport loops can be divided into groups. The facility of FIG. 2a has four intrabay transport groups, group1, group2, group3, and group4. Group1 100, group3 110, and group4 115 can be connected to tool bays bay1, bay2, bay4, bay5, bay6, and bay7 and to each other. The intrabay cross transports 140 and 145 can connect intrabay transport loop group1 to intrabay transport group4. The intrabay cross transports 150 and 155 can connect intrabay transport loop group3 to intrabay transport group4. Intrabay transport group2 105 can be isolated from group1 100 at isolation point 170. The isolation point can prevent materials from being moved directly from an object connected to intrabay transport group1, group3, or group4 to an object that is connected to intrabay transport group2. The isolation point 170 can be used when the materials being processed by the tools in a bay or multiple bays should be moved to a storage unit before proceeding to tools in tool bays not connected to the isolated intrabay transport loop. The interbay transport loop may be used to move a material from an isolated intrabay transport loop to another intrabay transport loop. The logical isolation of a intrabay transport loop can be created by not including a data structure in the configuration file for an intrabay cross transport between two intrabay transport loops even though the intrabay cross transport physically exists. A facility may have intrabay transport loops that are physically isolated from other intrabay transport loops. Physically isolated intrabay transport loops can be treated the same as logically isolated intrabay transport loops. The intrabay transport loops 100, 105, 110, and 115 can operate in a counterclockwise direction in one embodiment.

The tool bays connected by the intrabay transport loops can include multiple tools used to perform tasks on the materials. The seven tool bays may include a total of 30 tools tool1-tool30 in one embodiment.

FIG. 2b depicts a side view of an embodiment of a storage unit SU2 depicted in FIG. 2a. The storage unit SU2 can connect to an upper interbay transport system 165, a lower interbay transport system 160, and the intrabay transport system 100 in one embodiment.

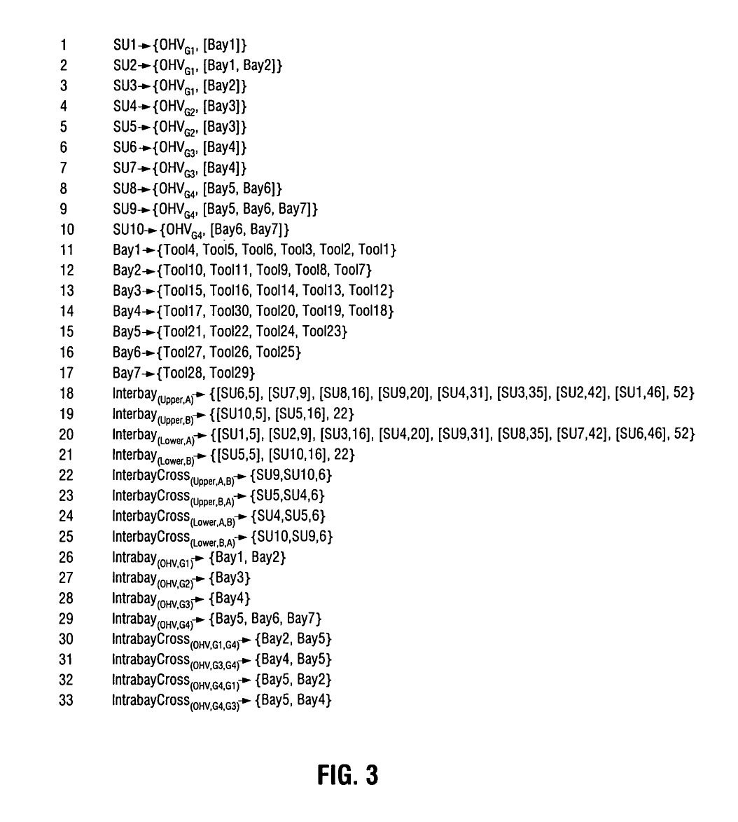

FIG. 3 is a configuration file representation of the facility depicted in FIG. 2a.

The parts of the configuration file can be storage system data structures, process system data structures, and transport system data structures. The storage system data can include data structures representing the interbay transport loops connected to the storage units and the tool bays supported by the storage units. The process system data can include data structures representing the tools in each tool bay. The transport system data can include data structures representing the intrabay transport loops, the interbay transport loops, the intrabay cross transports and the interbay cross transports. The intrabay transport loop data can include data structures representing the tool bays supported by that intrabay transport loop and the intrabay cross transport. The interbay transport loop data can include data structures representing the storage units connected to an interbay transport loop and the distance of the storage units from a point. The interbay cross transport data can include data structures representing a storage unit exit point, a storage unit entry point, and a distance between the entry and exits points. The intrabay cross transport data can include data structures representing the tool bays connected by the intrabay cross-transport.

Lines 1-10 of the example configuration file can include the storage unit-to-tool bay assignment. A storage unit can support the tool bays connected to the same intrabay transport loop. For example, storage unit SU1 is connected to intrabay transport group1 and can support tool bays that are connected to intrabay transport group1. Intrabay transport group1 is connected to tool bays bay1 and bay2; therefore storage unit SU1 can be connected to bay1, bay2, or both bay1 and bay2.

Lines 11-17 of the example configuration file can identify tools associated with tool bays in the facility. For example, bay1 includes tool1-tool6 and bay2 includes tool7-tool11.

Lines 18-33 of the example configuration file can identify the interbay transport loops, the interbay cross-transports, the intrabay transport loops, and the intrabay cross-transports.

The order of information and the structure of the data in a configuration file can be represented differently provided the necessary data for the algorithm is provided in the configuration file.

The data structure of an interbay transport loop can include each storage unit and that storage unit's position. The data structure also can include the total length of the interbay transport loop.

The interbay cross-transports can connect groups A and B. The locations of the interbay cross-transports can be identified by the storage units on each side of the interbay cross-transport and the length between those storage units.

The data structure representing the intrabay transport loops can include the tool bays connecting to those intrabay transport groups.

The data structure representing the intrabay cross-transports can include the tool bays on each side of the intrabay cross-transport.

When the control system receives an instruction to move a material, the algorithm can use the positions of the storage units on the interbay transport loop as one component of the algorithm for finding a more efficient route. For example, the control system can receive an instruction to move a material from storage unit SU1 to storage unit SU8. The material can be moved on either the upper interbay transport loop or the lower interbay transport loop.

When the algorithm determines a more efficient route, one component can be the length of a route from a source to a destination. The algorithm can determine multiple routes and compare the length of the routes.

The algorithm can use line 18 of the configuration file to determine the length of the route using the upper interbay transport loop to move a material from storage unit SU1 to storage unit SU8. In this example, the position of SU8 is 16 units, the position of SU1 is 46 units, and the length of the total upper interbay transport loop is 52 units. The positions of each storage unit can be relative to a fixed point 120. To determine the length of a route the algorithm may subtract the source position from the destination position. When the direction of an interbay transport loop may move a material across a fixed point 120, the algorithm can include the total length of the interbay transport loop by subtracting the total length of the interbay transport loop from the position of the starting point.
16−(46−52)=22

The route from storage unit SU1 to storage unit SU8 on the upper interbay transport loop is 22 units.

The algorithm can use line 20 of the configuration file to determine the length of the route using the lower interbay transport loop to move a material from storage unit SU1 to storage unit SU8. For the lower interbay transport loop, the position of storage unit SU1 is 5 units and the position of storage unit SU8 is 35 units. The position of the source, storage unit SU1 can be subtracted from the position of the destination storage unit SU8.
35−5=30

The route from storage unit SU1 to storage unit SU8 on the lower interbay transport loop is 30 units.

The equations that can be used by an algorithm can be different to compensate for transport systems that operate in different directions. As can be seen, the shortest route may be 22 units and the upper interbay transport loop can be used if all other factors are comparable.

The position of the tool bays on the intrabay transport loop is not shown in the example configuration file since there is only one intrabay transport path to each tool. The positions of tool bays can be included in the configuration file. The position of the tool bays may be used when multiple intrabay transport paths connect to the same tool.

In the example of FIGS. 2a, 2b, and 3 there are three transport systems that create multiple routes between the 10 storage units and 30 tools.

The number of routes between storage units is the number of storage units, multiplied by the number of storage units that can be a destination if one storage unit is the source. The number of routes between storage units can then multiplied by the number of interbay transport loops. There are two interbay transport loops, ten storage units, and nine possible destinations for a total of 180 routes between a storage unit and another storage unit.

The total routes between tools are the total number of tools in connected intrabay groups multiplied by the possible destination tools if one tool is the source. There is one intrabay, twenty-five tools, and twenty-four possible destinations of other tools in group1, group3, and group4, for a total of 600 routes between tools in those groups. In group2, there are five tools and four possible destination tools for each of the five tools, for a total of 20 routes between the tools in group2. Between the storage units and the tools associated with tool bay1, there are twenty-four routes. Between the storage units and tools associated with tool bay2, there are 20 routes. With tool bay3 and bay4 there are also twenty routes. With the storage units and tools associated with tool bay5, there are sixteen routes, with tool bay6 there are eighteen routes, and with tool bay7 there are eight routes, for a total of 926 direct routes between storage units and tools.

The intrabay cross-transports add additional routes. From the eleven tools in group1 to the five tools in group2, there are 1,100 routes; and from the eleven tools in group1 to the five tools in group3, there are 1,100 routes; and from the eleven tools in group1 to the nine tools in group4, there are 1,980 routes, for a total of 4,180 intrabay cross-transport routes.

A total of 5,106 routes are available between objects in the example facility and those routes can be manually input and stored in a static table.

The static-route table exponentially increases with the addition of each tool or storage unit. Manufacturing facilities may contain over seventy-five storage units and 300 tools.

When using the static-route table, it can be determined ahead of time, which transport system to use first. To change the priority of a transport system after the static-route table is complete can be difficult when the system is in operation. Using the algorithm to calculate the shortest path can allow the weights to be adjusted when each move is requested. The adjusted weights can select the transport system offering a more efficient route.

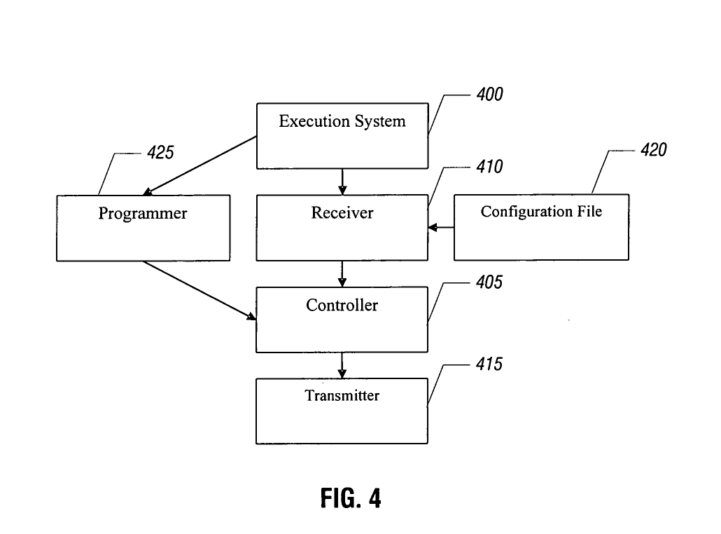

FIG. 4 depicts one embodiment of a device to control a facility. The execution system 400 can send a move request and a material priority to a receiver 410. The receiver can receive the configuration file 420. The programmer 425 can receive from the execution system 400 the type of move that is being requested. The programmer 425 can program the controller 405 with the correct algorithm to use based on the type of move requested by the execution system 400. The receiver 410 can transmit to the controller 405 the move request including the source, destination, and priority information received from the execution system 400. The receiver can send the information from the configuration file 420 to the controller 405. The controller can use the algorithm programmed by the programmer 425 to determine a more efficient route for the move requested by the execution system 400. A more efficient route may include reducing the number of exchanges between various transport and storage systems. When a more efficient route has been determined, the transmitter 415 can send a signal to execute the move of the material requested by the execution system 400 along the route determined by the controller 405.

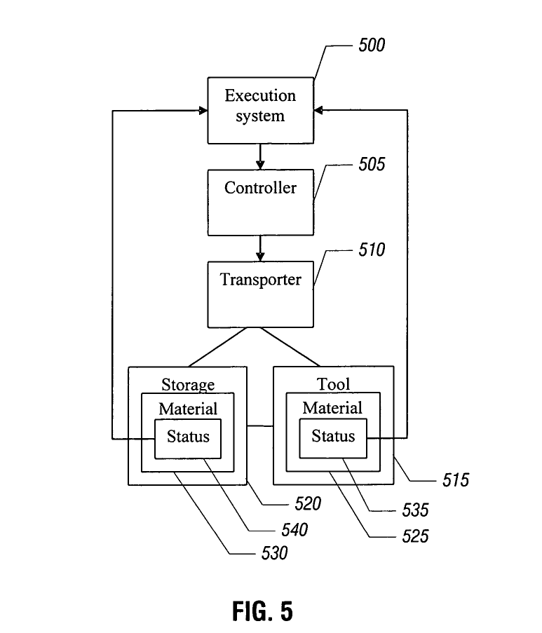

FIG. 5 depicts one embodiment of system in a facility. The execution system 500 can send information to the controller 505 requesting a move of a material from a storage unit to a tool, a tool to a storage unit, a tool to a tool, or a storage unit to a storage unit. Once the controller has calculated a more efficient route and transporter to use in block 505, the information can be sent to the transporter 510.

The transporter 510 can be connected to storage 520 and tools 515. Within the tools, there can be materials 525 and within the storage units there can be materials 530. When a tool 515 has completed work on a material 525, the status of that material 535 can be updated in the execution system 500. The status 540 of the material 530 can be sent to the execution system 500. The execution system can track the status of the materials in the tools 515 and the status of materials in the storage 520. The execution system can use the statuses 535 and 540 to determine where to move the materials 525 and 530 next. That next move can be sent to the controller 505. The controller 505 can calculate a more efficient route and control the transporter 510 to execute the move.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
generating a route to move material in a facility using a digital model of the facility including a representation of objects, the objects' distance from a point and a representation of at least two transport systems to transport the material between the objects.

2. The method of claim 1 including generating a signal to move the material along the generated route.

3. The method of claim 1 including generating a table with a plurality of routes before a route is requested.

4. The method of claim 1 including generating a route dynamically when the route is requested.

5. The method of claim 1 including assigning costs to different transports and selecting a route by considering the transport cost.

6. The method of claim 1 including assigning a plurality of move types for routes between different types of objects and assigning different priorities to different types of moves.

7. The method of claim 6 including assigning different move types to routes from storage to storage, from storage to tool, from tool to storage and from tool to tool.

8. The method of claim 1 including generating a route in a semiconductor fabrication facility.

9. The method of claim 1 including defining within said facility a number of bays which include groups, each group including tools of a particular type.

10. The method of claim 9 including assigning different transports for routes within a bay and routes outside of a bay.

11. The method of claim 1 including determining whether a transport is available for a particular route and, if not, selecting another transport.

12. The method of claim 1 including assigning a priority level to different materials and applying the priority level when generating the route.

13. A device comprising:
a controller to apply a digital model of a facility including locations of objects and locations of at least one transport system and the controller to apply an algorithm to calculate a route from a source object to a destination object in response to receiving a source object information and a destination object information.

14. The device of claim 13 including the controller to send a signal to move a material along the calculated route.

15. The device of claim 13 including the controller to select a route by considering the transport cost from the costs assigned to different transports.

16. The device of claim 13 including the controller to apply priorities to a plurality of move types for routes between different types of objects.

17. The device of claim 13 including the controller to calculate a route in a semiconductor fabrication facility.

18. The device of claim 13 including the controller to select another route if a transport is not available for a particular route.

19. A system comprising:
at least two transport systems to transport a material between objects; and
a controller to generate a route to move material in a facility using a digital model of the facility including a representation of the objects, the objects' distance from a point and a representation of the at least two transport systems to transport the material between the objects.

20. The system of claim 19 including the controller to send a signal to move a material along the generated route.

21. The system of claim 19 including the controller to generate a table with a plurality of routes before a route is requested.

22. The system of claim 19 including the controller to generate a route dynamically when the route is requested.

23. The system of claim 19 including the controller to select a route by considering the transport cost from the costs assigned to different transports.

24. The system of claim 19 including the controller to apply priorities to a plurality of move types for routes between different types of objects.

25. The system of claim 19 including a number of bays in the facility which include groups, each group including tools of a particular type.

26. The system of claim 19 including the controller to select another route if a transport is not available for a particular route.

27. A computer readable medium comprising instructions that, if executed, enable a processor-based system to:
generate a route to move material in a facility using a digital model of the facility including a representation of objects, the objects' distance from a point and a representation of at least two transport systems to transport the material between the objects.

28. The computer readable medium of claim 27 further comprising instructions that, if executed, cause the system to generate a signal to move the material along the generated route.

29. The computer readable medium of claim 27 further comprising instructions that, if executed, cause the system to generate a table with a plurality of routes before a route is requested.

30. The computer readable medium of claim 27 further comprising instructions that, if executed, cause the system to determine whether a transport is available for a particular route and, if not, cause the system to select another transport.
